(19) United States
(12) Patent Application Publication
(10) Pub. No.: US 2017/0249619 A1
(43) Pub. Date: Aug. 31, 2017

(54) RECEIPT ISSUING DEVICE AND CONTROL METHOD THEREFOR

(71) Applicant: SEIKO INSTRUMENTS INC., Chiba-shi (JP)

(72) Inventor: Seiichi JIMBO, Chiba-shi, Chiba (JP)

(21) Appl. No.: 15/425,175

(22) Filed: Feb. 6, 2017

(30) Foreign Application Priority Data
Feb. 29, 2016 (JP) 2016-037572

(51) Int. Cl. G06Q 20/20; G06Q 20/04

(52) U.S. Cl. CPC G06Q 20/209; G06Q 20/0453

(57) ABSTRACT

A receipt issuing device operably connected to an external host device and an external storage device, including a communication circuit configured to receive receipt data from the external host device, the receipt data including a print start command and receipt information; an external storage device detector configured to detect a wireless communication with the external storage device; an electronic receipt writer configured to write an electronic receipt based on the receipt information to the external storage device; an printing unit configured to printing a receipt based on the receipt information onto a printing medium; and a controller configured to determine, based on a result of the detection by the detector in acquiring the print start command, whether to perform a process of issuing the electronic receipt with the electronic receipt writer or a process of printing the receipt with the printing unit, and upon detecting the signal from the detector, cause to perform the process of the issuing the electronic receipt.

### BACKGROUND OF THE INVENTION

1. Field of the Invention

The present invention relates to a receipt issuing device and a control method therefor.

2. Description of the Related Art

As a device in a store or the like configured to receive input of sales, perform money deposit and withdrawal, and issue a receipt, there is known a point of sale (POS) system. In general, this type of POS system prints receipts with a POS terminal (cash register) when a customer pays for an item.

In recent years, however, many stores are shifting to a paperless system, and hence it is desired that receipts be digitalized. Therefore, a technology of using paper receipts and digitalized receipts (electronic receipts) for different purposes as needed is employed.

In view of the above, in this technical field, there is a demand for a receipt issuing device which has a simple configuration and is capable of easily issuing an electronic receipt, and a control method therefor.

### SUMMARY OF THE INVENTION

According to one embodiment of the present invention, there is provided a receipt issuing device operably connected to an external host device and an external storage device, including communication circuit configured to receive receipt data from the external host device, the receipt data including a print start command and receipt information; an external storage device detector configured to detect a wireless communication with the external storage device; an electronic receipt writer configured to write an electronic receipt based on the receipt information to the external storage device; an printing unit configured to printing a receipt based on the receipt information onto a printing medium; and a controller configured to: determine, based on a result of the detection by the detector in acquiring the print start command, whether to perform a process of issuing the electronic receipt with the electronic receipt writer or a process of printing the receipt with the printing unit, and upon detecting the signal from the detector, cause to perform the process of the issuing the electronic receipt.

In the above-mentioned receipt issuing device according to the one embodiment of the present invention, the controller is configured to transmit processing result information to the external host device, the processing result information indicating whether the controller has determine to perform the electronic receipt issue processing or the print processing.

According to one embodiment of the present invention, there is provided a control method for a receipt issuing device operably connected to an external host device and an external storage device, the receipt issuing device configured to perform print processing of printing a receipt based on receipt information received from the external host device onto a printing medium, the control method comprising: acquiring receipt data including a print start command and the receipt information; detecting a wireless communication with the external storage device; generating an electronic receipt based on the receipt information and writing the electronic receipt to the external storage device upon detecting the wireless communication with the external storage device in acquiring the print start command; and printing the receipt upon not detecting the wireless communication with the external storage device in acquiring the print start command.

### BRIEF DESCRIPTION OF THE DRAWINGS

FIG. 1 is a view for illustrating an exemplary configuration of a POS system according to a first embodiment of the present invention.

FIG. 2 is a block diagram for illustrating an exemplary configuration of a printer device according to the first embodiment.

FIG. 3 is a flowchart for illustrating an example of receipt issue processing according to the first embodiment.

FIG. 4 is a flowchart for illustrating an example of receipt issue processing according to a second embodiment of the present invention.

### DETAILED DESCRIPTION OF THE PREFERRED EMBODIMENTS

Embodiments of the present invention are now described with reference to the drawings.

First, a first embodiment of the present invention is described.

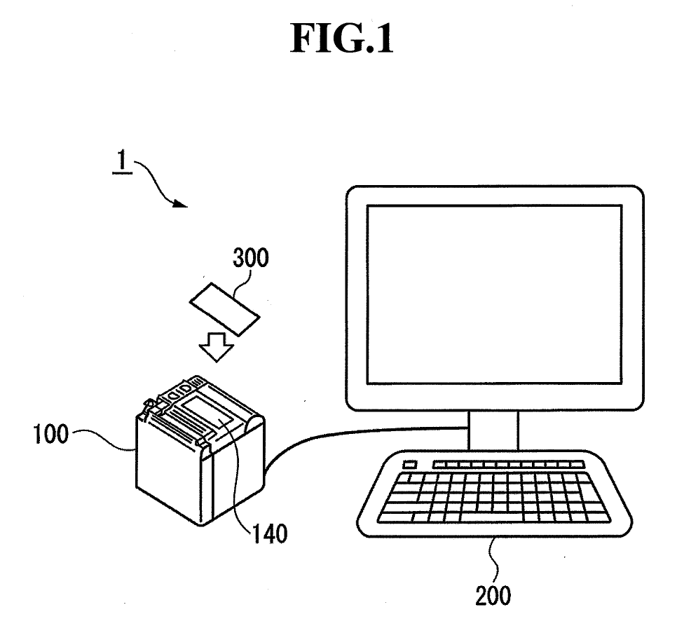

FIG. 1 is a view for illustrating an exemplary configuration of a POS system 1 according to this embodiment. The POS system 1 includes a printer device 100 and a host device 200. The external host device 200 is a POS terminal to which a product name and a price thereof are input, and on which operations such as issuing a receipt and conducting various settings for the POS system are performed. For example, when an operation to issue a receipt is performed on the external host device 200, the external host device 200 transmits receipt data including a print start command instructing the issue of the receipt and receipt information to be printed on the receipt to the printer device 100 based on the input product name and price thereof.

The printer device 100 is a line printer configured to print image data for every line. For example, the printer device 100 is connected to the external host device 200 for communication via Universal Serial Bus (USB), Recommended Standard 232 Version C (RS-232C), Bluetooth (trademark), or another communication method. Then, the printer device 100 receives the receipt data transmitted from the external host device 200 and prints the receipt based on the received the receipt information of the receipt data.

Further, the printer device 100 has a function of generating an electronic receipt based on the received receipt information. For example, the printer device 100 includes an external storage device 300 and an external communication interface 140 which is connectable to the external storage device 300 for communication. The printer device 100 writes the generated electronic receipt to the external storage device 300 via the external communication interface 140.

The external communication interface 140 is configured to communicate with the external storage device 300 compatible with Near Field Communication (NFC), which is a standard for near field wireless communication, or the like. For example, the external storage device 300 is an IC card compatible with NFC or the like. When the external storage device 300 is held over the external communication interface 140, the external communication interface 140 and the external storage device 300 are connected to each other for communication, and the electronic receipt can be written to the external storage device 300 via the external communication interface 140.

For example, when the external storage device 300 is connected to the external communication interface 140 for communication, the printer device 100 generates the electronic receipt and writes the electronic receipt to the external storage device 300, without printing a receipt. On the other hand, when the external storage device 300 is not connected to the external communication interface 140 for communication, the printer device 100 prints the receipt and does not generate the electronic receipt.

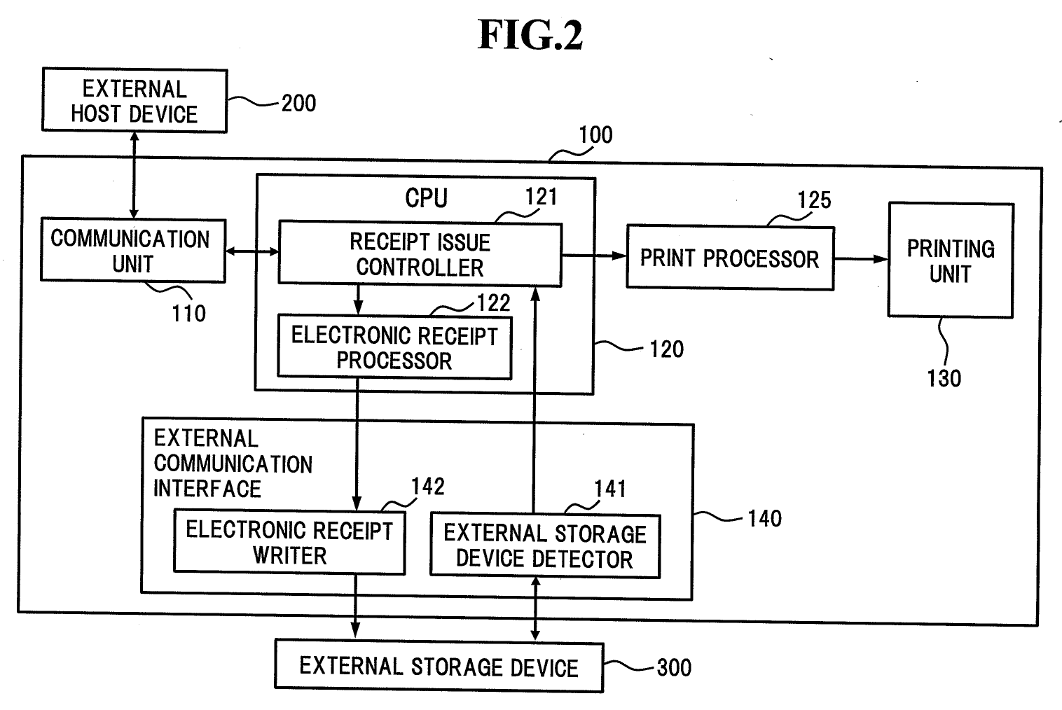

Next, a configuration of the printer device 100 is described in detail. FIG. 2 is a block diagram for illustrating an exemplary configuration of the printer device 100 according to this embodiment. The printer device 100 includes a communication unit (communication circuit) 110, a CPU 120, a print processor 125, a printing unit (printing mechanism) 130, and the external communication interface 140.

The communication unit 110 is a communication interface configured to connect to the external host device 200 for communication, and communicates with the external host device 200 by a predetermined communication method. The communication interface for connecting to the external host device 200 for communication as the communication unit 110 may be, for example, a communication interface using USB, a communication interface using RS-232C, or a communication interface using Bluetooth. For example, the communication unit 110 receives the print start command and the receipt information transmitted from the external host device 200 and outputs the print start command and the receipt information to the CPU 120.

The CPU 120 is constructed from a central processing unit (CPU), and is configured to control each of the units of the printer device 100. For example, the CPU 120 acquires the print start command received by the communication unit 110, and the CPU 120 causes the printer device 100 to perform receipt issue processing of issuing the receipt based on the receipt information transmitted from the external host device 200 after the acquisition of the print start command. For example, the CPU 120 causes the printer device 100 to perform, as the receipt issue processing based on the received print data, any one of receipt print processing of printing the receipt, and electronic receipt issue processing of generating the electronic receipt and writing the electronic receipt to the external storage device 300.

The print processor 125 performs the receipt print processing in accordance with the control by the CPU 120 to print the receipt based on the receipt information onto a printing medium using the printing unit 130. The printing medium is, in general, paper (in particular, thermal paper), but may be made of any material as long as the receipt information can be printed thereon.

The printing unit 130 is configured to print the receipt based on the receipt information received from the external host device 200 in accordance with the receipt print processing performed by the print processor 125. For example, the printing unit 130 prints the receipt information (print data) for every line sequentially received from the external host device 200 in the order of reception. Then, when all the receipt information (print data) for one page (one receipt) has been printed, the receipt print processing ends. When the printing medium is the thermal paper, the printing unit 130 is a thermal printer mechanism including a thermal head and a platen roller opposing the thermal head.

As described above, the external communication interface 140 is configured to communicate with the external storage device 300 compatible with NFC. The external communication interface 140 includes an external storage device detector 141. The external storage device detector 141 is configured to detect whether or not the external communication interface 140 is connected to the external storage device 300 for communication. Further, the external communication interface 140 includes an electronic receipt writer 142. The electronic receipt writer 142 is configured to write the electronic receipt based on the receipt data to the external storage device 300.

Next, a specific functional configuration of the CPU 120 is described. For example, the CPU 120 includes a receipt issue controller 121 and an electronic receipt processor 122. The receipt issue controller 121 acquires the print start command received by the communication unit 110, and the receipt issue controller 121 performs the receipt issue processing based on the receipt information transmitted from the external host device 200 after the acquisition of the print start command. At this time, the receipt issue controller 121 determines whether or not the external storage device 300 is connected to the external communication interface 140 for communication based on a result of the detection by the external storage device detector 141, and selects any one of printing the receipt and issuing the electronic receipt.

For example, when the receipt issue controller 121 determines that the external storage device 300 is connected to the external communication interface 140 for communication, the receipt issue controller 121 causes the electronic receipt processor 122 to perform the electronic receipt issue processing, without causing the print processor 125 to perform the receipt print processing. On the other hand, when the receipt issue controller 121 determines that the external storage device 300 is not connected to the external communication interface 140 for communication, the receipt issue controller 121 causes the print processor 125 to perform the receipt print processing, and does not cause the electronic receipt processor 122 to perform the electronic receipt issue processing.

Information indicating whether the receipt issue controller 121 has caused the receipt print processing or the electronic receipt issue processing to be performed may be transmitted to the external host device 200 via the communication unit 110.

The electronic receipt processor 122 is configured to perform the electronic receipt issue processing. For example, the electronic receipt processor 122 generates the electronic receipt based on the receipt information, and writes the electronic receipt to the external storage device 300 via the external communication interface 140 (electronic receipt writer 142).

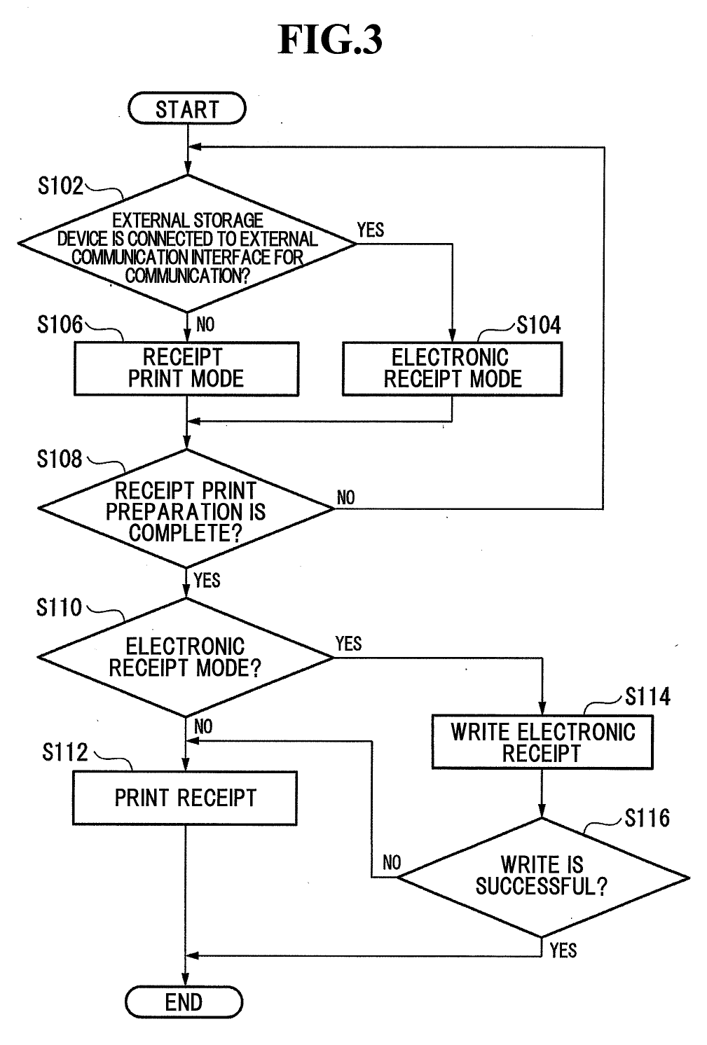

Next, with reference to FIG. 3, operation of the receipt issue processing, which is performed by the printer device 100, is described. FIG. 3 is a flowchart for illustrating an example of the receipt issue processing according to this embodiment. The receipt issue processing illustrated in FIG. 3 starts when the printer device 100 receives the print start command from the external host device 200.

(Step S102) When the CPU 120 acquires the print start command received by the communication unit 110, the CPU 120 determines whether or not the external storage device 300 is connected to the external communication interface 140 for communication based on a result of the detection by the external storage device detector 141. When it is determined that the external storage device 300 is connected for communication (YES), the processing proceeds to Step S104. On the other hand, when it is determined that the external storage device 300 is not connected for communication (NO), the processing proceeds to Step S106.

(Step S104) When the CPU 120 determines in Step S102 that the external storage device 300 is connected for communication, the CPU 120 selects an electronic receipt mode in which the electronic receipt issue processing is performed, and the processing proceeds to Step S108.

(Step S106) When the CPU 120 determines in Step S102 that the external storage device 300 is not connected for communication, the CPU 120 selects a receipt print mode in which the receipt print processing is performed, and the processing proceeds to Step S108.

(Step S108) The CPU 120 determines whether or not receipt print preparation is complete. Specifically, when the reception of receipt information (print data) for one line is complete, the CPU 120 determines that the receipt print preparation is complete. On the other hand, when it is determined that the reception of receipt information (print data) for one line is not complete, the CPU 120 determines that the receipt print preparation is not complete. Then, when the CPU 120 has determined that the receipt print preparation is complete, the processing proceeds to Step S110. On the other hand, when the CPU 120 has determined that the receipt print preparation is not complete, the processing returns to Step S102.

(Step S110) The CPU 120 determines whether or not the electronic receipt mode is set. When it is determined that the electronic receipt mode is not set (that is, when the receipt print mode is set) (NO), the processing proceeds to Step S112, and the CPU 120 causes the print processor 125 to perform the receipt print processing. On the other hand, when it is determined that the electronic receipt mode is set (YES), the processing proceeds to Step S114, and the CPU 120 causes the electronic receipt processor 122 to perform the electronic receipt issue processing.

(Step S112) The print processor 125 performs the receipt print processing using the printing unit 130 to print the receipt based on the receipt information. The printing unit 130 prints the receipt information (print data) for every line that is successively received from the external host device 200 in the order of reception. Then, when all the receipt information (print data) for one page (one receipt) has been printed, the receipt print processing ends.

(Step S114) The electronic receipt processor 122 performs the electronic receipt issue processing. For example, when the receipt information (print data) for all the lines on one page (one receipt) has been received, the electronic receipt processor 122 generates the electronic receipt based on the received receipt information (print data) for the one page (one receipt). Then, the electronic receipt processor 122 performs processing of writing the generated electronic receipt to the external storage device 300 via the external communication interface 140 (electronic receipt writer 142).

(Step S116) The electronic receipt processor 122 determines whether or not, in Step S114, the write of the electronic receipt is successful. When the write is successful (YES), the electronic receipt processor 122 ends the electronic receipt issue processing. On the other hand, when the write is unsuccessful (NO), the electronic receipt processor 122 transmits information indicating that the write is unsuccessful to the receipt issue controller 121. An unsuccessful write may be caused by a recognition error (card recognition error) of the external storage device 300, or memory shortage (lack of free space for writing) of the external storage device 300, or the like. In this case, the CPU 120 forcibly changes the mode to the receipt print mode. When the receipt issue controller 121 receives the information indicating that the write is unsuccessful from the electronic receipt processor 122, the processing proceeds to Step S112, and the print processor 125 is caused to perform the receipt print processing as substitute processing for the electronic receipt issue processing.

As described above, the printer device 100 according to this embodiment includes the print processor 125, the external communication interface 140, the electronic receipt processor 122, and the receipt issue controller 121. The print processor 125 is configured to perform the receipt print processing of printing the receipt based on the receipt information onto the printing medium. The external communication interface 140 is configured to communicate with the external storage device 300. The electronic receipt processor 122 is configured to generate the electronic receipt based on the receipt information, and perform the electronic receipt issue processing of writing the electronic receipt to the external storage device 300 via the external communication interface 140 (electronic receipt writer 142). Further, when the external storage device 300 is connected to the external communication interface 140 for communication, the receipt issue controller 121 causes the electronic receipt processor 122 to perform the electronic receipt issue processing, without causing the print processor 125 to perform the receipt print processing.

In this way, the printer device 100 detects whether or not the external storage device 300 is connected for communication, and issues the electronic receipt when the external storage device 300 is connected for communication. Therefore, work related to settling payment does not increase, there is no need for a device with which a customer indicates their desire for a receipt, for example, a button or a touch panel, and the electronic receipt can be easily issued with a simple configuration. Further, the printer device 100 receives the print start command and the receipt information from the external host device 200, to thereby be able to perform the processing of issuing the electronic receipt on the printer device 100 side. Therefore, even in a POS system that is not compatible with electronic receipts, by using the printer device 100 according to this embodiment, the electronic receipt can be issued without having a change on the external host device side.

Meanwhile, when the external storage device 300 is not connected to the external communication interface 140 for communication, the receipt issue controller 121 causes the print processor 125 to perform the receipt print processing, and does not cause the electronic receipt processor 122 to perform the electronic receipt issue processing. In this way, the printer device 100 can print the receipt when the external storage device 300 is not connected for communication. Therefore, the printer device 100 can select any one of printing the receipt and issuing the electronic receipt based on the customer's needs.

Further, the external communication interface 140 includes the external storage device detector 141 configured to detect whether or not the external storage device 300 is connected to the external communication interface 140 for communication. The receipt issue controller 121 is configured to determine whether or not the external storage device 300 is connected to the external communication interface 140 for communication based on a result of the detection by the external storage device detector 141. In this way, the printer device 100 can detect whether or not the external storage device 300 is connected for communication and perform appropriate processing out of printing the receipt or issuing the electronic receipt based on the result of the detection.

Further, the receipt issue controller 121 is configured to transmit information indicating whether the receipt issue controller 121 has caused the print processor 125 to perform the receipt print processing or has caused the electronic receipt processor 122 to perform the electronic receipt issue processing. In this way, the printer device 100 can transmit a receipt issue form indicating whether the receipt has been printed or the electronic receipt has been issued to the external host device 200 after the receipt is issued. In other words, the POS system 1 can record the receipt issue form and use the receipt issue state for investigation of the needs of customers, issue frequency of the electronic receipt, or the like.

Next, a second embodiment of the present invention is described. In this embodiment, processing of a case in which an error has occurred in the printer device 100 in the receipt print mode is described. The error to occur in the printer device 100 is, for example, a lack of paper, an open cover, or the like. The open cover refers to a state in which a closeable cover covering a paper storage unit or the like in the printer device 100 is open. A basic configuration of the POS system 1 and the printer device 100 according to this embodiment is the same as that of the first embodiment illustrated in FIG. 1 and FIG. 2, and hence description thereof is omitted, and characteristic processing according to this embodiment is described below.

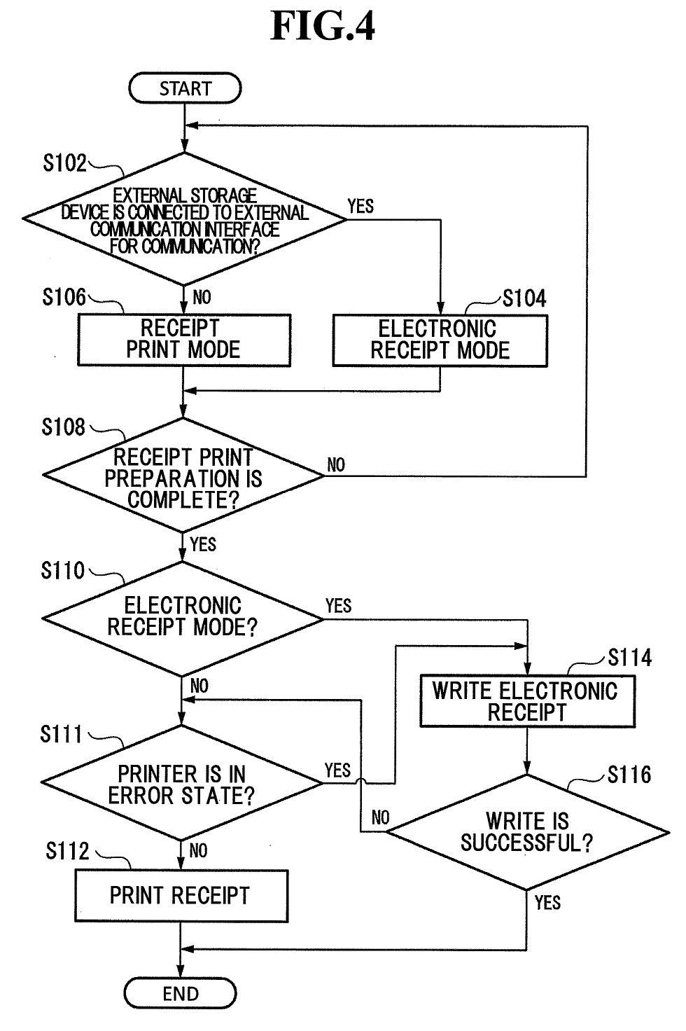

FIG. 4 is a flowchart for illustrating an example of receipt issue processing according to this embodiment. Operation of the receipt issue processing according to this embodiment is described with reference to FIG. 4. In FIG. 4, processing similar to the processing of FIG. 3 is denoted by the same reference symbols, and description thereof is omitted as necessary. The receipt issue processing according to this embodiment is different from the receipt issue processing illustrated in FIG. 3 in that processing of Step S111 has been added.

(Step S110) The CPU 120 determines whether or not the electronic receipt mode is set. When it is determined that the electronic receipt mode is not set (that is, when the receipt print mode is set) (NO), the CPU 120 advances the processing to Step S111.

(Step S111) The print processor 125 determines whether or not the printer device 100 is in an error state. For example, the print processor 125 uses a detection sensor (not shown) to confirm whether or not an error, for example, the lack of paper or the open cover, has occurred, and then determines whether or not the printer device 100 is in an error state. When it is determined that the printer device 100 is not in an error state (NO), the processing proceeds to Step S112, and the print processor 125 performs the receipt print processing. On the other hand, when it is determined that the printer device 100 is in an error state (YES), the print processor 125 advances the processing to Step S114.

In Step S114, the electronic receipt processor 122 performs the electronic receipt issue processing. However, the external storage device 300 is not connected for communication, and hence a write error occurs in Step S116. Then, the processing returns to Step S111.

Here, when the error state of the printer device 100 is resolved, the processing proceeds to Step S112, and the print processor 125 performs the receipt print processing. On the other hand, when the error state of the printer device 100 is not resolved, the processing proceeds to Step S114 again, and the print processor 125 performs the electronic receipt issue processing. When the external storage device 300 is connected for communication before the error state of the printer device 100 is resolved, in Step S116, the electronic receipt processor 122 successfully writes the electronic receipt (YES) and ends the electronic receipt issue processing.

As described above, when the printer device 100 according to this embodiment is in an error state in the receipt print mode, the printer device 100 can issue a receipt in a receipt issue form corresponding to any one of the error state being resolved and the external storage device 300 being connected for communication, whichever occurs at an earlier time. Therefore, with the printer device 100, it is possible to reduce the length of a state in which the receipt cannot be issued as much as possible.

All or a part of the function of each unit included in the printer device 100 according to the embodiments described above may also be implemented by recording a program for implementing those functions in a computer-readable recording medium, and reading and executing the program recorded in the recording medium on a computer system. As used herein, the term “computer system” may include an operating system (OS) and hardware, for example, a peripheral device.

The term “computer-readable recording medium” refers to portable media, such as a flexible disk, a magneto-optical disc, a ROM, and a CD-ROM, or a storage unit included in the computer system, for example, a hard disk. The term “computer-readable recording medium” may also refer to a medium configured to dynamically hold a program for a short period of time, like a communication cable when transmitting a program via a network, for example, the Internet, or a communication line, for example, a telephone line, or to a medium configured to hold a program for a fixed period of time, like a volatile memory in a computer system serving as a server or a client in such a case. The above-mentioned program may be a program for implementing a part of the above-mentioned functions, or may be capable of implementing the above-mentioned functions in combination with a program already recorded in the computer system.

The embodiments of the present invention are described above, but the present invention is not limited to those embodiments, and various modifications can be made within the range not departing from the gist of the present invention.

A configuration including at least the respective units of the receipt issue controller 121, the electronic receipt processor 122, the print processor 125, and the external communication interface 140 of the printer device 100 according to the above-described embodiments can be defined as a receipt issuing device. The receipt issuing device in this case is not limited to the printer device 100, and may be used for various purposes as a receipt issuing device.

What is claimed is:

1. A receipt issuing device operably connected to an external host device and an external storage device, comprising:
a communication circuit configured to receive receipt data from the external host device, the receipt data including a print start command and receipt information;
an external storage device detector configured to detect a wireless communication with the external storage device;
an electronic receipt writer configured to write an electronic receipt based on the receipt information to the external storage device;
a printing unit configured to print a receipt based on the receipt information onto a printing medium; and
a controller configured to:
determine, based on a result of the detection by the detector in acquiring the print start command, whether to perform a process of issuing the electronic receipt with the electronic receipt writer or a process of printing the receipt with the printing unit, and
upon detecting the signal from the detector, cause to perform the process of the issuing the electronic receipt.

2. A receipt issuing device according to claim 1, wherein the controller is configured to transmit processing result information to the external host device, the processing result information indicating whether the controller has determine to perform the electronic receipt issue processing or the print processing.

3. A control method for a receipt issuing device operably connected to an external host device and an external storage device,
the receipt issuing device configured to perform print processing of printing a receipt based on receipt information received from the external host device onto a printing medium,
the control method comprising:
acquiring receipt data including a print start command and the receipt information;
detecting a wireless communication with the external storage device;
generating an electronic receipt based on the receipt information and writing the electronic receipt to the external storage device upon detecting the wireless communication with the external storage device in acquiring the print start command; and
printing the receipt upon not detecting the wireless communication with the external storage device in acquiring the print start command.
